(19) United States
(12) Patent Application Publication
(10) Pub. No.: US 2011/0109108 A1
(43) Pub. Date: May 12, 2011

(54) Hand held material carrying tool

(76) Inventor: John Scott Westmoreland, Silver City, NM (US)

(21) Appl. No.: 12/798,570

(22) Filed: Apr. 6, 2010

Related U.S. Application Data
(60) Provisional application No. 61/281,254, filed on Nov. 12, 2009.

(51) Int. Cl. E04G 21/16; A45F 5/00; B25J 1/00

(52) U.S. Cl. 294/86.4; 294/137; 294/149; 294/150; 294/141

(57) ABSTRACT

A one piece material carrying tool (37) having a handle (46C) at one end of said tool, and a material holder (44) at the other end of said tool.

A material carrying tool having material holders (15A-15B) attached to adjusting arms (17A-17B) attached with a sliding means to fixed arms (18A-18B). Said fixed arms (18A-18B) are attached in between frame half's (19A-19B) so said arms (17A-17B) and (18A-18B) can pivot. Said frame half's (19A-19B) are fixed to a mount (21), said mount (21) is attached to a handle (22).

### BACKGROUND

1. Field of Invention

This invention relates to a hand held tool for carrying sheets of plywood, drywall, sheet metal, bundles of pipe, lumber and other materials for professionals and nonprofessionals.

2. Description of Prior Art

An online patent search for prior articles of this tool was conducted with inconclusive results. The key words used were (hand held material carrying tool) with zero results, and (hand held plywood carrying tool) also with zero results. Foreign patents were not searched.

This material handling, or carrying tool was first mentioned in a Provisional Patent Application filled by the inventor on Nov. 12, 2009, application No. 61/281,254, titled “Orion”—all in one clamping tool. Initially, both tools would have been applied for in the Orion application. However, it is felt the two tools should be applied for separately, the primary reason is it would not be fair to those who do not want the clamp, but may want the material carrier only. These people should not be forced to buy one tool to get the benefits of the other. A worker who has the clamp could still use it for a material carrier as described in the Orion application. Also, there would be a vast cost difference between the two tools, including manufacturing cost. In addition, the material carrier is much lighter and easier to use.

The following is a background description and the necessity for the material carrying tool applied for.

All builders whether they are working on a home improvement project or the major housing tracts are prone to carrying large heavy sheets of material, and other objects. Objects such as piping, lumber, drywall and plywood. Some sheets of drywall are ten to twelve feet in length making them very hard to handle. Many modern homes with cathedral ceilings and long walls use the ten to twelve foot drywall, or sheetrock. Many roofs today are sheathed with plywood or particle board, and are two story or split level homes with large square footages. This means the worker must carry his/her sheet material from the stack to the point of placement which is either the subfloor, or the roof of the house. Subflooring is usually ⅝ths. or ¾rs. inch tongue and groove plywood or particle board which is quite heavy.

Normally large sheets of plywood and drywall are carried somewhat over the head of the worker with the left or right hand holding the lower edge of the sheet. The center of the sheet would rest on the left or right shoulder and the other hand holds the upper edge of the sheet which is above the head. This is due to the size of a full sheet of material which is four feet wide by eight feet long. With the exception of ten and twelve foot drywall. The point is, carrying these large sheets can be vary hazardous. Example, a worker carrying a large heavy sheet above his/her head creates a high center of gravity, and blocks much of the workers vision on the side the sheet is carried. In this case, a high center of gravity would make it very easy for a worker to trip on a obstacle or other due to blocked vision from the blind side.

Lifting a large heavy sheet can cause pulled muscles if lifting or moving the wrong way. Further hazards are, a worker falling off a roof from a sudden unexpected gust of wind with a sheet of plywood in his/her hands. This event is by far the most dangerous safety hazard. Even if the worker let go of the sheet to avoid falling, the free floating sheet could still strike someone on the ground. Or strike a truck or other equipment which is usually parked near a jobsite. If a worker lost his/her balance from a similar situation with the wind, could fall thru the rafters or floor joist. The tool would give a worker far better control of this and other situations. Due to the low center of gravity, a worker could brace the sheet with his/her lower body. Also, the material is carried much lower to the surface and can be set down quickly preventing further movement, and the sheet could be used to regain lost balance. This tool would be a tremendous help in preventing workman's compensation claims, which would be a great savings to everyone.

Other advantages are the ease in which a worker can carry bulky objects such as pipes and lumber. It is a known fact that most plastic pipe is sold in 20 foot lengths, although plastic pipe is not heavy, carrying six or eight pieces of four or six inch diameter pipe can be harder than is seems. This includes lumber as well, lumber is heavier especially when wet, and like pipe, is usually carried balanced on the shoulder of the worker.

The human shoulder is somewhat round and can cause the material being carried to scissor or spread out as shown in FIG. 12. This method may cause pieces to fall, or be dropped, then perhaps tripped over. Or one must stop, set the material down, readjust the load, pick up the load again and go. With this tool, one simply wraps the nylon straps around the load while on the ground, (which could be more than one could carry by hand), hooks the straps to the tool, tightens the straps and goes. The straps keep the load intact while carrying, and while tying to the truck rack or other. Loads can be carried easily with one hand, this means lumber, pipe, plywood, drywall, including objects like fence post or other. Thus giving freedom to the other hand for opening gates, doors, or move objects in the workers way such as saw horses. One could even climb a ladder which requires at least three points of contact. Older people, within reason, can use this tool for yard work such as cut branches saving them back strain from bending over or other. Used lumber that still has nails imbedded can be carried easily without harm to the worker. If the nails are bent over they can still scratch which can cause infections.

Carrying large heavy objects even partially over one's head is not a wise thing to do, especially if there is a safer and easier alternative. Consider how much plywood is used in formwork for bridges, high-rise construction, and for shielding pedestrians as they pass by a jobsite. This tool is for repetitive handling of those heavy bulky objects, making the job far safer and easier in the process.

### OBJECTS AND ADVANTAGES

The advantages of the present invention are many, most of which are for the safety and wellbeing of all workers, not only construction, but other fields as well. This is the primary object of the tool. In addition, insurance companies would benefit greatly with fewer injury payouts. Construction companies could be offered a reduced premium from their insurance carrier for using this tool. This could be a huge savings for everybody. Any device that saves employees or anyone from personal injuries is a worthy endeavor. Fall protection harnesses, steel toe safety boots, plastic safety glasses, hard hats, high visibility vest, gloves, respirators, guards around machinery belts, fire extinguishers, etc., all are worthy safety articles for protecting people from injuries. All the above safety articles are mandatory personal protection equipment required by O.S.H.A., Occupational Safety and Health Administration, and M.S.H.A., Mine safety and Health Administration. Both are huge federal agencies, and stiff fines can and are issued to both company and employee for violations of these requirements. There are many more safety requirements regulated by these agencies, far too many to list. Injury payouts to workers from insurance companies is only about three quarters of what the worker makes normally. In this present economy lost revenue could be disastrous to a family.

In any event, it is the goal of this invention to: (A) Provide a tool that can easily be manufactured in this country, thus providing jobs. (B) Provide an affordable and easy to use tool anybody can use. (C) Provide a tool that will help prevent serious personal injuries and property damage. (D) Provide a tool that can be used for many different tasks or objects making the job of carrying safer and easier. (E) Provide a means of saving money for many people, this correlates with (C) above. (F) Provide a tool that can be stored in a toolbox. (G) Provide a tool that is practical and convenient.

Further objects and advantages will become apparent from the description and drawings.

### DRAWING FIGURES

In the drawings similar parts may have closely related numbers but with different alphabetical suffixes. Also, FIGS. 4 thru 10 are of different embodiments which will be reviewed in a separate description entitled—SECONDARY EMBODIMENTS. FIGS. 11 to 13 are illustration views.

FIG. 1 is a front isometric view of the tool which is the preferred embodiment, and a optional pipe or lumber carrying attachment used with the tool.

FIG. 2 is a side view of the same tool in FIG. 1, and with the pipe and lumber attachment in place.

FIG. 3 is a front view of a typical sheet of material, plywood or drywall, and how the tool would be used to carry material.

FIGS. 4, 4A, is a view of a secondary embodiment and related parts.

FIG. 5 shows a simple attachment (accessory part) that could be used with the tool.

FIG. 6 shows a front view of a secondary embodiment and related parts.

FIG. 7 is a side view of the same tool in FIG. 6, the thickness of the tool in this drawing is greatly exaggerated for clarity reasons.

FIGS. 8 and 9 are views of typical straps that would be used on any of the tools, preferred embodiment or secondary embodiment.

FIG. 10 is a illustration view of the straps together positioned around a load of pipe.

FIGS. 11, 12, and 13 are illustration views of various kinds.

### REFERENCE NUMERALS AND PARTS LIST

Reference numerals 15A thru 36A are used in the secondary embodiments section. Numerals 37 thru 50 are used in the preferred embodiment section which will be the first description.

15A-15B, material holders./16A-16B, loose rivets./17A-17B, adjustable arms. 18A-18B, fixed arms./18C-18D, mount stops./19A-19B, frame half's./ 20A-20B, wing nuts./20C-20D, wing nut bolts./21, handle mount. 21A-B-C-D, handle mount rivets./22, hand grip./23, hand grip hinge./ 24, hand grip latch and hinge./24A, latch catch./25A-25B, release levers./ 25C-25D, arm locks./26A-26B, release lever springs./27A-27B, release lever mounting pins./28A-28B-28C-28D, release lever hinges./29A-29B, release lever mounts./ 30, arm lock pin./30A, arm lock pin spring./31, material holder buckle, or clip buckle./ 32, primary strap buckle./33, secondary strap lock buckle./33A, lock buckle retainer./ 34, secondary strap retainer teeth./34B, mounting pin./35A-35B, buckle hinges./ 35C, hinge pin or rivets./36, primary strap./36A, secondary strap./

### Preferred Embodiment Numerals

37, one piece material carrying tool./38, pipe attachment./38A-38B, attachment braces./ 39A-39B, brace rivets./40A-40B, strap hooks./41, attachment mounting bracket./ 42A-42B-42C, hand grip openings./43, mounting hole./43A, attachment brace bolt./ 43B, attachment wing nut./44, material holder, or clip./45A-45B, plastic end covers./ 46D-46E, folding extension arms./46F, handle frame./46G, flanges./46H, handle./ 47, wheel./47A, wheel mount./48, load of lumber./49, load of pipe./50, sheet material./

### SUMMARY

In harmony with the present invention, a one piece material carrying tool comprising a ridged material of predetermined size capable of withstanding predetermined weight, and at least one hand grip at one end of the tool, and a material holder at the other end of the tool.

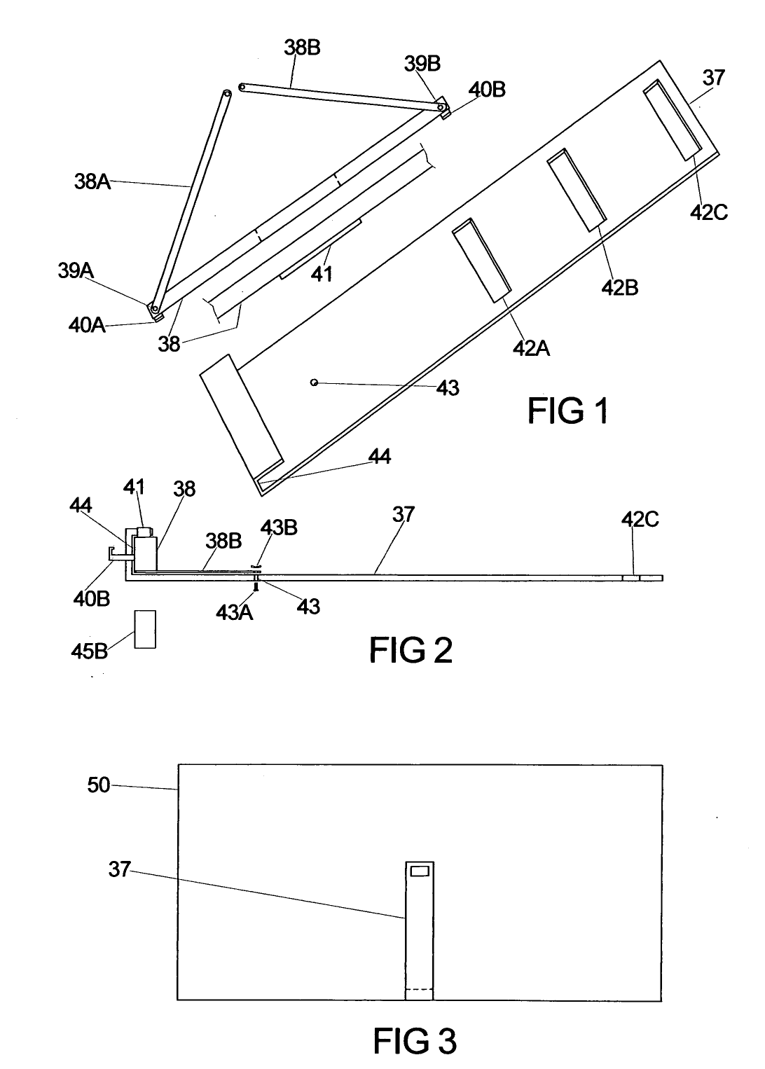

### DESCRIPTION—FIGS. 1 TO 3

A typical embodiment of the tool of the present invention is illustrated in FIG. 1. This simple tool 37 has no moving parts, and is constructed as one piece which could be stamped heavy gauge steel sheet metal. Or two lighter layers of stamped steel sheet metal spot welded together to form one piece. As the part(s) are being stamped, shallow channels or long indentations are pressed into the part. These indentations give strength to the part and would give a sense of thickness to the tool when placed together stamped side out. Then spot welded together forming a one piece tool. This provides a strong but light weight tool. A hand grip 42C is punched out and the excess bent over to form a smooth hand grip, FIG. 1. The one piece tool 37 could be constructed of plastic in a plastic injection mold process or other.

At least one hand grip at the top is provided which will accommodate the average size human being of five feet eight inches tall. The average arm length of a five foot eight inch tall person is about 22 inches. The length of the tool is approximately 28 inches from the hand grip 42C to the seat of the material holder or material clip 44. Thus the arm length of 22 inches would give approximately 2 inches of clearance from the bottom edge of a sheet 48 inches wide to the floor. The width of the tool is approximately six to seven inches. This puts the top edge of a sheet directly under the arm of the worker. If this does not give enough clearance the sheet can be carried outside the arm instead of under. This means the right or left free hand must hold the sheet from falling away from the outside of witch ever arm is carrying the sheet. The material is still carried low to the ground, no blocked vision, far less back strain, etc. However, with the addition of more hand grip openings 42A-42B, as seen in FIG. 1, large sheets can be carried by almost anyone. The material holder 44 is also stamped into form with the same indentations for strength, FIG. 1. The material holder is nothing more than a square U shape stamped into the end, see FIGS. 1 and 2. This shape will hold sheets of plywood, drywall, doors, sheet metal, sheet glass such as sliding glass doors windows etc. The width of holder 44 is enough to carry one inch material, which means two sheets of ½ inch plywood can be carried easily.

A pipe attachment 38, shown in FIGS. 1 and 2, could be an optional feature or provided with the tool. Some people may not want the pipe attachment. In any case, attachment 38 fits directly into material holder 44 and kept from lateral movement by a attachment mounting bracket 41, shown in FIGS. 1 and 2. Mounting bracket 41 is bent and riveted to the outside of attachment 38 and fits around the outside lip of holder 44 when attachment 38 is seated in place. Attachment 38 is hollow square steel stock cut to a predetermined length with plastic end covers 45A-45B on each end, FIG. 2. Only one end cap 45B is shown in FIG. 2 for clarity reasons. A pair of pipe attachment braces 38A-38B, are fastened to each end of attachment 38 with rivets 39A-39B, FIG. 1. The rivets have enough play so braces can pivot. Also, this allows braces 38A-38B to fold down along the side of attachment 38 when not in use. When in use, braces 38A-38B are folded up to a mounting hole 43 in tool 37 shown in FIGS. 1 and 2. A attachment brace bolt 43A, and wing nut 43B hold 38A-38B in place which gives support to attachment 38 when in use, FIGS. 1 and 2. A primary strap 36 and secondary strap 36A cut to a predetermined length are typical straps that would be used on any of the tools in the drawings, see FIGS. 8 and 9. There are two sets of straps and buckles, only one set of straps and buckles are shown in the drawings, except in FIG. 13 of illustration views.

FIG. 10 shows how the straps are united and placed around a typical load of pipe 49 or lumber 48, FIGS. 10 and 13. In FIG. 8 strap 36 is much longer than shown, it was intended to show that a clip buckle 31 and strap buckle 32 are connected to a common strap, see FIG. 10. The secondary strap(s) 36A are designed to be pulled toward the user which is much easier when tightening a load, FIG. 10. In FIG. 10, the straps are placed around a load, and a clip buckle 31 and strap lock buckle 33 are placed together and hung on a set of strap hooks 40A-40B on attachment 38 shown in FIGS. 1 and 2. With attachment 38 placed in tool 37, and the straps tight around a load, hand grip 42A could be used to carry the load.

In FIGS. 8, 9, and 10, primary strap(s) 36-secondary strap(s) 36A-clip buckle(s) 31-strap buckle(s) 32-strap lock buckle(s) 33-keeper(s) 33A-and strap retainer(s) 34, are typical of what would be used on a preferred or secondary embodiment. Straps 36 and 36A are flexible material cut to a predetermined length such as woven nylon, and sewn around the respective buckle opening, FIGS. 8, 9, and 10. Buckle 31 and 33 are stamped steel with openings of a given size to accommodate: the straps 36 and 36A, strap hooks 40A-40B, or material holders 15A-15B. Strap lock buckle 33 is stamped steel with openings, and a set of teeth cut in a given direction, FIG. 9. Strap retainer 34 is stamped steel with the addition of a strap retainer pivoting lock 34A, and is the other half of buckle 33, FIG. 9. Both retainer 34 and buckle 33 are held together with buckle hinges 35A-35B, FIG. 9. Pivot lock 34A is held in place with a mounting pin 34B. The teeth of lock 34A and buckle 33 hold strap 36A from slipping under a load weight, FIG. 9. A keeper 33A in FIG. 9, is drawn on the outside of buckle 33 for clarity reasons. Actually, it is kept from coming off its place with the tabs at the top of buckle 33, yet allowed to slide back and forth. Keeper 33A will slide over retainer 34 and under buckle 33 when strap 36A is in place, FIG. 10.

Retainer 34 has a wedged shape so keeper 33A will tighten when pushed down, or back, this holds retainer 34 from opening under a load. The pivoting lock 34A has a rounded face with teeth cut in a given direction and pivots forward when strap 36A is pulled to tighten a load, FIGS. 9 and 10. Then keeper 33A is slid over retainer 34 and locked. When the load is lifted, the heavier the weight pulling back on the strap, the tighter pivot lock 34 will hold, as long as keeper 33A is in place. Keeper 33A is also a quick release mechanism, one simply pulls back on keeper 33A which allows retainer 34 to open, loosening the load, FIGS. 9 and 10.

Although this tool is simple, strong, and light, it should be understood that this tool is not confined to the form and construction described above.

### Operation—FIGS. 1, 2, and 3

A worker knowing that he/she is going to carry a sheet of plywood 50, FIG. 3, simply stands the material on one of its edges. One end of the sheet should be raised enough so the material holder 44 can seat to the bottom edge in the center of the sheet, FIG. 3. Raising and holding the end of a sheet up can be done by using a small 2×4 scrap, or if nothing else, the toe of one's boot. Then with the tool 37 in place, using one of the hand grips 42A-42B-42C, the material can be lifted slightly and carried. Using pipe attachment 38 the square shape fits into material holder 44. Mounting bracket 41 is placed over the outside lip of holder 44, see FIGS. 1 and 2. Attachment braces 38A-38B are moved or swiveled up and lapped so both braces can be bolted with 43A and 43B in hole 43, FIGS. 1 and 2. Straps 36 and 36A are coupled by sliding strap 36A thru the opening in buckle 32 and wrapped around a load, FIG. 10. Both buckles 31 and 33 are coupled on hooks 40A-40B at each end of 38. Strap 36A is pulled tight around the load, FIG. 13. Keeper 33A is pushed forward to lock, and the load can be safely and easily carried.

### SUMMARY, RAMIFICATIONS, AND SCOPE

In accordance with the present invention and description the reader can see the advantages of this tool. A hand held tool can simplify the task of carrying bulky or heavy materials, and help to eliminate personal injury and property damage. This is the object of the tool, and to help create a safer work environment.

The following is a description of the secondary embodiments and ramifications.

### Secondary Embodiments

This tool can have many shapes and sizes, some are as simple as the preferred embodiment. Example: a simple rope or nylon strap with hooks. The rope or strap is the handle and arms of the tool, the rope having knots tied or eyelets in the strap for adjustment increments. The hooks are placed around a knot or hooked in a eyelet, the other end of the hook is placed on the edge of the sheet to be carried. The rope or strap can be wrapped around pipes and lumber, then the hooks attached to the knots or eyelets. The above description would include steel cables, leather straps or other similar materials.

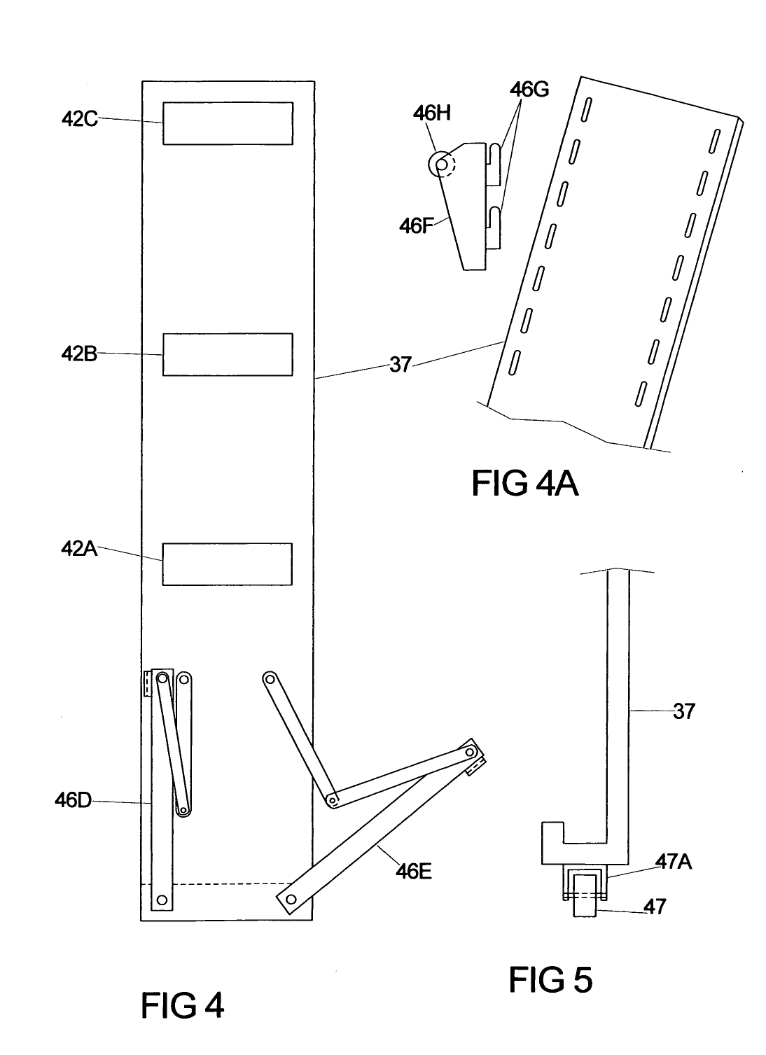

Easy improvements to the preferred embodiment shown in FIGS. 4, 4A, and 5 are: (A) Rather than having a separate attachment 38, FIG. 1, for carrying pipes and lumber, an extension could be attached to the back of tool 37 with loose rivets. The arms 46D and 46E would be folding extensions, and work in the same manner as attachment 38, FIG. 4. (B) A small wheel 47 could be easily attached to the bottom of tool 37. This wheel would be an optional feature purchased separately. The advantage of the wheel would help dry wallers when handling long sheets. In most all cases, sheet rocking is done before the carpeting is installed. As a result, the bare concrete floor could be used making it far easier to roll a long heavy sheet. This wheel option could be used on a subfloor as well. Rolling a ten or twelve foot sheet would be easy, especially with two people working. A rotational device, or wheel 47, mounted on a shaft that is part of a wheel mount 47A, could be hard plastic or steel. In any case, it would be an inexpensive aid to the worker, FIG. 5. (C) An adjustable hand grip 46H rather than three or four fixed grips should be considered. Fixed grips are simply much firmer with no protrusions. However, a adjusting hand grip 46H would provide better comfort and would fit a wider range of people. The handle frame 46F, holds flanges 46G which slide and lock into the slots spaced evenly apart in tool 37, FIG. 4A.

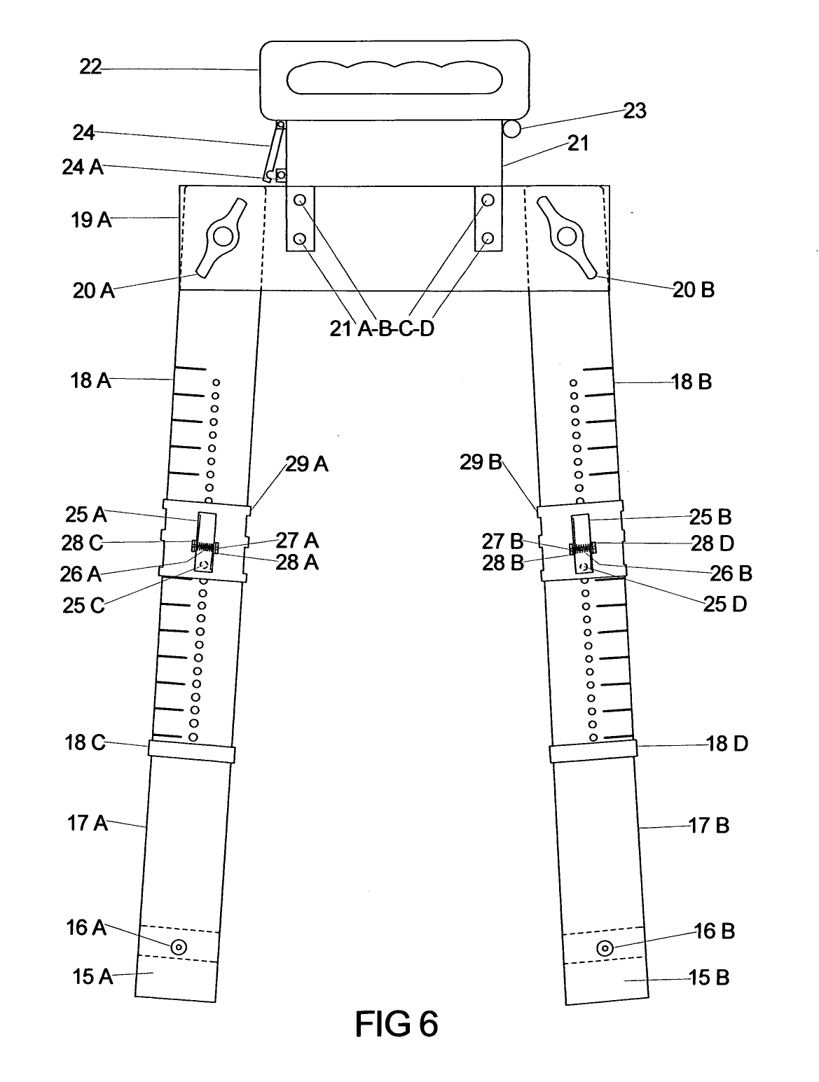

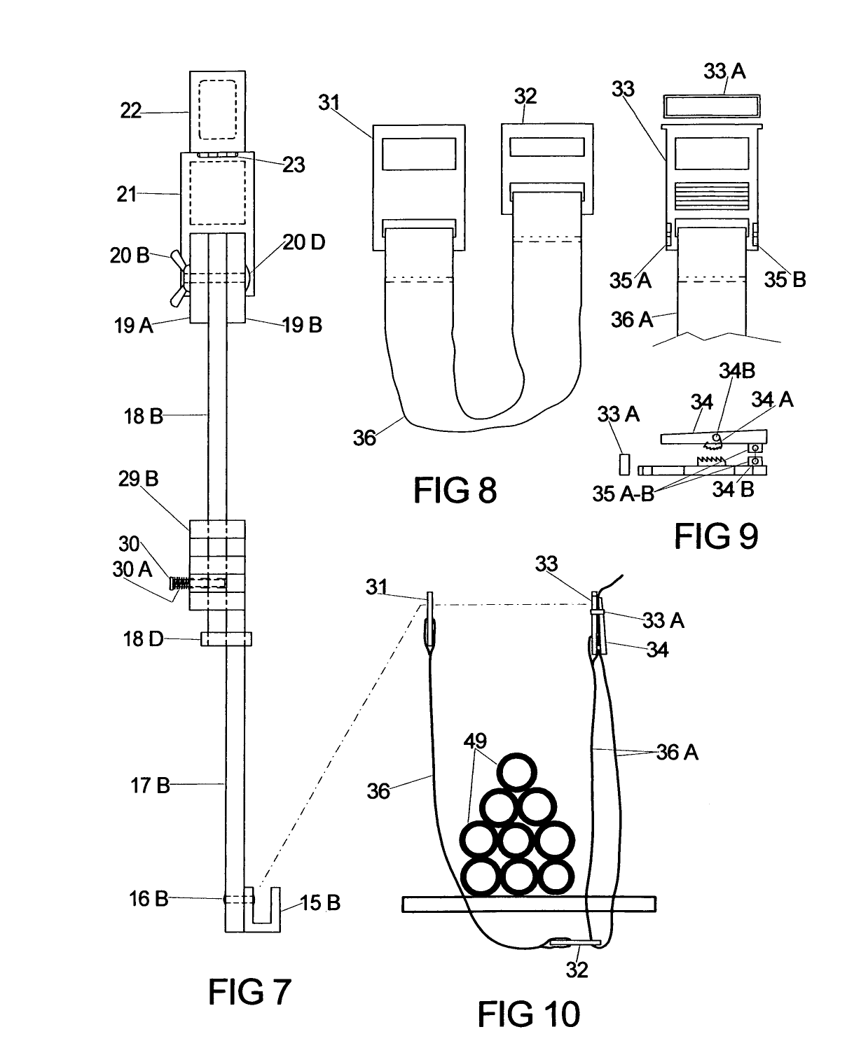

A further secondary embodiment is of a different design, but still considered a material carrying tool, FIG. 6. The tool closely resembles the Orion—all in one clamping tool, “patent pending” application No. 61/281,254: filed Nov. 12, 2009. The tool shown in FIGS. 6 and 7, comprising a ridged material capable of withholding a predetermined weight. A pair of material clips, or material holders 15A-15B are fastened to a pair of adjusting arms 17A-17B, with loose rivets 16A-16B.

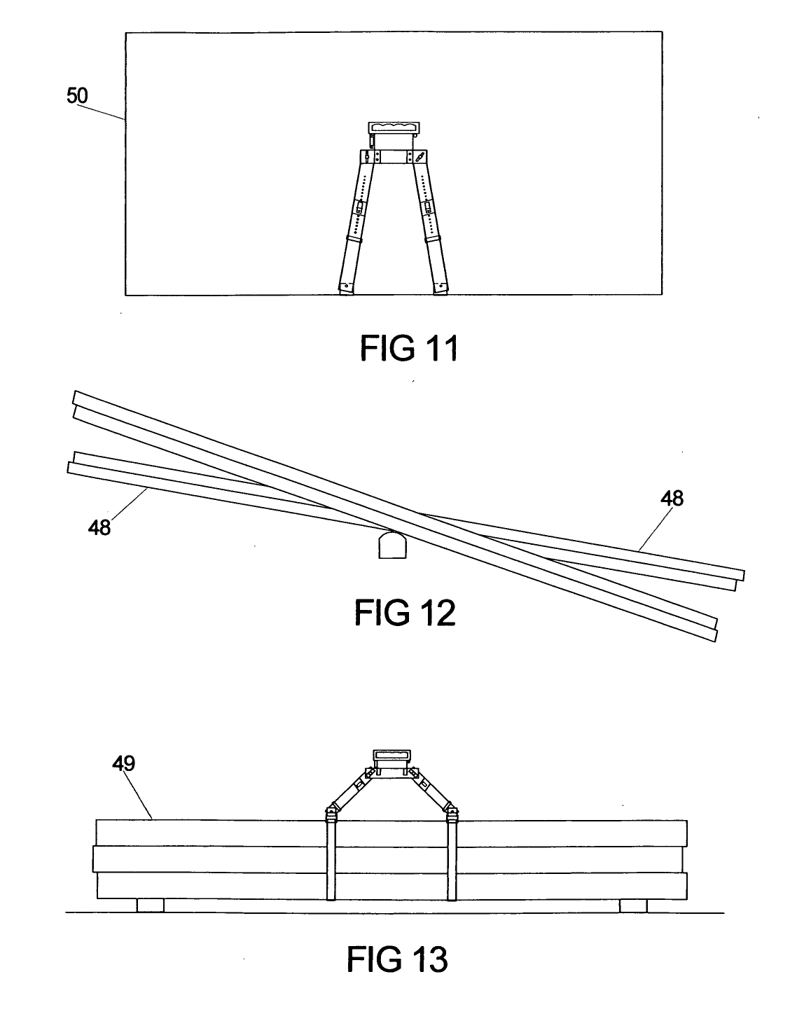

Arms 17A-17B slide on fixed arms 18A-18B which are bolted in between frame half's 19A-19B with bolts 20C-20D, and wing nuts 20A-20B, FIGS. 6 and 7. A hollow handle mount 21 is fixed to the top of the frame half's with handle mount rivets 21A-B-C-D, FIG. 6. A handle 22 is fixed to mount 21 with a hinge 23, a handle/latch 24, and a latch/catch 24A. The hollow mount 21 is a place to store straps 36 and 36A when not in use. Attached to the bottom of arms 18A-18B are mount stops 18C-18D which prevent arms 17A-17B from sliding off arms 18A-18B, FIGS. 6 and 7. Arms 17A-17B are held against arms 18A-18B with release lever mounts 29A-29B which help keep arms aligned, and allow sliding as well as stops 18C-18D. Arms 18A-18B are drilled with a polarity of adjusting holes, mounts 29A-29B have one hole each, aligning with the holes in arms 18A-18B. Release levers 25A-25B have arm locks 25C-25D which fit into these holes in 18A-18B and 29A-29B, FIG. 6. Levers 25A-25B are held in place with release lever hinges 28A-28B, release lever pins 27A-27B and release lever springs 26A-26B, shown in FIG. 6. In FIG. 7, an arm lock pin 30, and spring 30A are shown as a possible alternative to levers 25A-25B. The above described tool is shown in FIGS. 11 and 13. A simple convenient addition to the tool could be adjustment increments etched into arms 18A-18B to help the user adjust arms 17A-17B evenly, FIG. 6.

The arms 18A-18B although fixed to the frame(s) 19A-19B can pivot in or out along with arms 17A-17B. This provides better support for large objects. Also, accurate adjusting of arms 17A-17B, will help fit a wider range of people. The tool can be constructed of many different materials, such as, inch and a ¼ wide by ⅛th. or 3/16ths. thick, common mild steel strapping would provide a strong and long lasting tool. Or plastic injection molding, or other material such as aluminum, any ridged material that is capable of withholding the weight of what can be carried by a person or the tool. The straps for this tool have been described in the above preferred embodiment section.

### Making and Using the Secondary Embodiment, FIGS. 6 and 7

Assuming the tool is made of at least one inch wide, by one eighth inch thick steel strapping for arms, 17A-17B, 18A-18B, and frame half's 19A-19B. Cut frame half's 19A-19B to a predetermined length, and drill holes centered at the ends of 19A-19B, so holes drilled in the top center of arms 18A-18B will line up, and arms fit flush to frame ends 19A-19B and will pivot, FIG. 6. With the arms 18A-18B cut to a predetermined length, drill a polarity of adjusting holes of a given size and spacing down the center of 18A-18B, FIG. 6. Bolt arms 18A-18B in between frame half's 19A-19B with bolts 20C-20D, and nuts 20A-20B. Cut adjusting arms 17A-17B to a predetermined length and drill a hole centered near the bottom end to mount material holders 15A-15B, FIGS. 6 and 7. Holders 15A-15B are cut pieces of the above material welded together forming a square shape and a hole drilled, then loosely riveted to arms 17A-17B with 16A-16B, FIGS. 6 and 7. Release lever mounts 29A-29B are pieces of the above material drilled with one hole each, and cut with flanges which are wrapped around arms 18A-18B to form a sandwich, then welded to the tops of arms 17A-17B so arms can slide, FIG. 7. The ends of arms 18A-18B are wrapped and welded with mount stops 18C-18D, which are narrow bands of the above stock bent around arms 17A-17B. Then welded, but not to arms 17A-17B, this forms a stop that arms 17A-17B can slide thru. Release levers 25A-25B are stamped steel forming a lever, with arm locks 25C-25D which are pins welded to the underside of 25A-25B, locks 25C-25D fit into the holes in mounts 29A-29B, and 18A-18B forming a locking means. Levers 25A-25B are mounted to the front, and over the holes in mount 29A-29B with hinges 28A-28B, lever pins 27A-27B, and lever springs 26A-26B which activate levers 25A-25B, FIG. 6. Attached to the front and back of half's 19A-19B is a mount 21 fixed in place with mount rivets 21A-B-C-D, FIG. 6. Mount 21 are pieces of material welded together, or cast aluminum, as is the handle 22. Mount 21 is large enough to hold both strap sets 36 and 36A when not in use. Attached to mount 21 is a handle 22 which will provide a lid for mount 21, and a griping means for the user. Handle 22 is attached to 21 with a hinge 23, handle/latch 24, and a latch/catch 24A. Parts 21, 22, 23, 24, and 24A can be made of cast aluminum, or plastic injection molding, or other.

Using the material carrying tool one simply adjusts the arms for width by loosening wing nuts 20A and 20B, than retighten. For length by pushing down on levers 25A and 25B to release lock pins 25C and 25D, to adjust. Lifting one end of the material, the clips 15A and 15B can be placed on the bottom edge, with the handle in hand, the sheet can be carried, see FIG. 11. Carrying pipe or lumber with straps 36 and 36A would be the same as described in operation section, FIGS. 1, 2 and 3 above, except the placement of clip buckles on holders 15A and 15B, FIGS. 11 and 13.

Other methods and improvements to the preferred embodiment would include a sliding locking handle, or a handle that could be relocated to a more comfortable spot, as in FIG. 4A. The one piece tool could be made of two small diameter aluminum pipes with a sliding locking handle, or other.

The objects and scope of this invention should be determined by the claims and their legal equivalents, rather than by the examples given.

I claim:

1. A one piece material carrying tool comprising;
(a) a ridged material of predetermined size, capable of withholding predetermined weight
(b) a griping means for a human hand at one end of said tool and,
(c) a holding means for material at the other end of said tool
whereby a worker can carry material safely and easily.

2. The one piece material carrying tool of claim 1 further including a ridged elongated material carrying attachment of predetermined size, and a brace support means connected to the ends of said carrying attachment.

3. The one piece material carrying tool of claim 2 further including a flexible material of a predetermined size and length capable of withholding predetermined weight, and a coupling means for said flexible material.

4. The one piece material carrying tool of claim 1 further including a folding extension means fixed to said tool for carrying material.

5. The one piece material carrying tool of claim 1 further including a rotational means on a mounting means attachable to said tool.

6. The one piece material carrying tool of claim 3 wherein said flexible material is nylon strapping.

7. The one piece material carrying tool of claim 3 wherein said coupling means are steel buckles with teeth for coupling said flexible material.

8. The one piece material carrying tool of claim 2 further including hooks fixed to the ends of said carrying attachment.

9. The one piece material carrying tool of claim 1 wherein said ridged material is stamped steel.

10. The one piece material carrying tool of claim 3 wherein said coupling means is a locking buckle means for holding said flexible material.

11. The one piece material carrying tool of claim 1 wherein said griping means is a adjustable griping means.

12. The one piece material carrying tool of claim 1 wherein said ridged material is aluminum.

13. A material carrying tool comprising;
a ridged material of predetermined size, a polarity of material holding means attached to adjustable arms with a pivoting means, said adjustable arms work in conjunction with fixed arms attached to a frame by a pivoting means, said frame is attached to a mount for a handle.

14. The material carrying tool of claim 13 further including a hollow mount for a handle.

15. The material carrying tool of claim 13 wherein said handle and said mount have hinges and a latch/catch means for holding said mount to said handle.

16. The material carrying tool of claim 13 further including a polarity of holes in said fixed arms for said adjusting arms.

17. The material carrying tool of claim 13 wherein said adjustable arms and said fixed arms have a sliding mount means, and a lever locking means attached to each said mount for adjusting.

18. The material carrying tool of claim 13 wherein said lever locking means works with a spring and pin connected to said mounts with hinges.

19. The material carrying tool of claim 13 wherein said ridged material is aluminum and steel.

20. A material carrying tool comprising a polarity of arms with a holding means fixed to one set of said arms for material, said arms are fixed to frame members which are fixed to a mounting member, said mounting member is fixed to a handle for a human hand.
